(19) United States
(12) Patent Application Publication
(10) Pub. No.: US 2022/0271462 A1
(43) Pub. Date: Aug. 25, 2022

(54) High-Current High-Frequency Electrical Connector Plug Applicable To Network Data Transmission

(71) Applicant: Goldenconn Electronic Technology Co., Ltd, Suzhou (CN)

(72) Inventors: Qunyu Li, Suzhou (CN); Song Zou, Suzhou (CN); Zhigang He, Suzhou (CN)

(21) Appl. No.: 17/375,693

(22) Filed: Jul. 14, 2021

(30) Foreign Application Priority Data
Feb. 20, 2021 (CN) 202110191595.3

(51) Int. Cl. H01R 13/213; H01R 13/646

(52) U.S. Cl. CPC H01R 13/213; H01R 13/646

(57) ABSTRACT

A high-current high-frequency electrical connector plug applicable to network data transmission includes a plug housing and a bayonet socket integrated in an inserted manner. The bayonet socket includes an upper terminal block, a lower terminal block and an insulating plastic body. An insertion cavity for placing a socket tongue of an electrical connector receptacle is formed in the insulating plastic body. The upper terminal block and the lower terminal block are inserted and fixed into the insertion cavity respectively. The periphery of the plug housing is sequentially provided with a left rounded part, a right rounded part, a left chamfered part and a right chamfered part. Specific sizes of the left rounded part and the right rounded part need to be controlled.

### CROSS-REFERENCE TO RELATED APPLICATIONS

This application is based on and claims the benefit of priority from Chinese Patent Application No. 202110191595.3, filed on 20 Feb. 2021, the entirety of which is incorporated by reference herein.

### TECHNICAL FIELD

The present disclosure relates to the field of electrical connector manufacturing technologies, and in particular, to a high-current high-frequency electrical connector plug applicable to network data transmission.

### BACKGROUND

Currently, with the rapid development of information industry and the continuous progress of electronic technology, more and more terminal devices are deployed over a network, applied in quite different scenarios and deployed at different time, and therefore a Power over Ethernet (PoE) switch is the best choice to remotely supply power to the devices. PoE refers to a technology that can provide DC power for some IP-based terminals (e.g., an IP phone, a wireless local network access point (AP), a network camera and a network TV base station for communication) while transmitting high-speed data signals without any changes to the existing Ethernet Cat.5 wiring infrastructure. The PoE technology may ensure the security of existing structured wiring, ensure the normal operation of an existing network, and reduce a wiring cost to the maximum extent.

With a power requirement of a power receiving terminal, e.g., a low-power high-definition video television (70W) and other high-definition display devices, the PoE power supply technology is required to be continuously upgraded, from the original 30 W power supply to 90 W, 100 W, or even 200 W in the future. With the arrival of 5G era, requirements on signal transmission rate and quality become higher and higher, an original Ethernet transmission interface has reached the bottleneck, and can no longer meet a growing market requirement. Therefore, an electric connector capable of implementing high-speed Ethernet transmission, high-power power supply and high-speed signal transmission is provided in view of the above. In the existing technology, the electrical connector is mainly formed by a connector receptacle and a connector plug through insertion. The connector receptacle includes a receptacle housing and a socket tongue. The socket tongue is built in and fixed in a cavity of the receptacle housing, and includes an upper terminal block, a lower terminal block and an insulating plastic body. The upper terminal block and the lower terminal block are both fixed to the insulating body and configured to transmit signals or power. The connector plug includes a plug housing and a bayonet socket. The bayonet socket is built in and fixed in the plug housing. When the connector plug is inserted in the connector receptacle, the plug housing is sleeved within the receptacle housing. During the insertion process, the plug housing slides along the receptacle housing. Meanwhile, the socket tongue is gradually inserted into the bayonet socket.

In the existing technology, as shown in FIG. 16 and FIG. 17, both of the cross sections of the receptacle housing and the plug housing are a rounded rectangle and are not provided with misinsertion proofing marks. As a result, when multiple connectors are applied side by side at the same time, mixed insertion and misinsertion of other connector plugs into the high-current high-frequency electric connector receptacle for network data transmission occur quite easily, consequently, inevitably causing signal connection errors, and even burn-in in severe cases. Therefore, it is urgent for a skilled person to solve the above problems.

### SUMMARY

Therefore, in view of the above existing problems and defects, the designer of the present disclosure collects relevant information, and finally a high-current high-frequency electric connector plug applicable to network data transmission is provided through continuous experiments and modifications by technicians engaged in the industry who have years of experience in research and development and through multi-party evaluation and consideration.

To solve the technical problem described above, the present disclosure relates to a high-current high-frequency electrical connector plug applicable to network data transmission. The electrical connector plug includes a plug housing and a bayonet socket. The periphery of the plug housing is provided with: a left rounded part formed by round corner transition of a bottom wall and a left side wall of the plug housing and having a radius not greater than 0.25 mm; a right rounded part formed by round corner transition of a right side wall and a bottom wall of the plug housing and having a radius not greater than 0.25 mm; a left chamfered part formed by chamfering of a left side wall and a top wall of the plug housing; and a right chamfered part formed by chamfering of a right side wall and a top wall of the plug housing. The bayonet socket is configured to be inserted and locked in the plug housing, and includes: an insulating plastic body provided with an insertion cavity; an upper terminal block fixed to a top wall of the insertion cavity and extending out of the insertion cavity; and a lower terminal block fixed to a bottom wall of the insertion cavity and extending out of the insertion cavity.

As a further improvement on the technical solution of the present disclosure, the insulating plastic body further includes a left fool-proofing inwardly-extending part and a right fool-proofing inwardly-extending part; and the left fool-proofing inwardly-extending part and the right fool-proofing inwardly-extending part are both formed by extending downwardly from the top wall of the insertion cavity.

As a further improvement on the technical solution of the present disclosure, the bayonet socket further includes: a left hook member, fixed into the insulating plastic body, and including a left hook formed by extending rightwards from a right side wall of the left hook member; and a right hook member, fixed into the insulating plastic body, and including a right hook formed by extending leftwards from a left side wall of the right hook member.

As a further improvement on the technical solution of the present disclosure, the plastic insulating body further includes: a left avoidance notch, formed on a left side wall of the insulating plastic body and configured to insert the left hook member; and a right avoidance notch, formed on a right side wall of the insulating plastic body and configured to insert the right hook member.

As a further improvement on the technical solution of the present disclosure, an upper limiting notch and a lower limiting notch are formed on the top wall and the bottom wall of the plug housing respectively; an upper limiting protrusion matched with the upper limiting notch is formed on a top wall of the insulating plastic body, the upper limiting protrusion is formed by extending upwardly from the top wall of the insulating plastic body, a lower limiting protrusion matched with the lower limiting notch is formed on a bottom wall of the insulating plastic body, and the lower limiting protrusion is formed by extending downwardly from the bottom wall of the insulating plastic body.

Compared with an electrical connector plug with a conventional design structure, in the technical solution in the present disclosure, an insertion part of the electrical connector plug adopts a small rounding design (a rounding size is reduced compared with a conventional electrical connector plug). Accordingly, the electrical connector receptacle matched with the electrical connector plug is structurally improved to fit the small rounding design. Thus, when multiple electrical connectors are arranged side by side, conventional electrical connector receptacles do not adopt an adaptive remodel design, and therefore the electrical connector plug in the present disclosure cannot be inserted into other electrical connector receptacles even if workers perform misoperation, mixed insertion and misinsertion of the electrical connector plug into other electrical connector receptacles are effectively prevented, and finally it is ensured that signals are correctly transmitted.

### BRIEF DESCRIPTION OF DRAWINGS

To describe the technical solutions in the embodiments of the present disclosure or in the existing technology more clearly, the following briefly describes the accompanying drawings required for describing the embodiments or the existing technology. Apparently, the accompanying drawings in the following description show merely some embodiments of the present disclosure, and a person of ordinary skill in the art may derive other drawings from these accompanying drawings without creative efforts.

FIG. 1 is a schematic 3D view of a high-current high-frequency electrical connector plug applicable to network data transmission in the present disclosure;

FIG. 2 is a schematic exploded view of a high-current high-frequency electrical connector plug applicable to network data transmission in the present disclosure;

FIG. 3 is a schematic 3D view of a plug housing in a high-current high-frequency electrical connector plug applicable to network data transmission in the present disclosure from one angle;

FIG. 4 is a front view of FIG. 3;

FIG. 5 is a schematic 3D view of a plug housing in a high-current high-frequency electrical connector plug applicable to network data transmission in the present disclosure from another angle;

FIG. 6 is a schematic 3D view of a bayonet socket in a high-current high-frequency electrical connector plug applicable to network data transmission in the present disclosure from one angle;

FIG. 7 is a front view of FIG. 6;

FIG. 8 is a schematic 3D view of a bayonet socket in a high-current high-frequency electrical connector plug applicable to network data transmission in the present disclosure from another angle;

FIG. 9 is a schematic 3D view of an insulating plastic body in a high-current high-frequency electrical connector plug applicable to network data transmission in the present disclosure from one angle;

FIG. 10 is a schematic 3D view of an insulating plastic body in a high-current high-frequency electrical connector plug applicable to network data transmission in the present disclosure from another angle;

FIG. 11 is a top view of FIG. 1;

FIG. 12 is a sectional view along a line A-A in FIG. 11;

FIG. 13 is a schematic diagram illustrating a state in which a high-frequency electrical connector plug applicable to IO data transmission is inserted into an electrical connector receptacle matched with the electrical connector plug in the present disclosure;

FIG. 14 is a sectional view along a line C-C in FIG. 13;

FIG. 15 is a schematic diagram illustrating an interference state in which a high-current high-frequency electrical connector plug applicable to network data transmission is inserted into a conventional electrical connector receptacle in the present disclosure;

FIG. 16 is a schematic 3D view of a conventional electrical connector receptacle in the existing technology;

FIG. 17 is a schematic 3D view of a conventional electrical connector plug in the existing technology;

FIG. 18-1 shows a Pin definition form in a long-distance 15G signal transmission state of a high-current high-frequency electrical connector plug applicable to network data transmission in a normal application state in the present disclosure;

FIG. 18-2 shows a Pin definition form in a long-distance 20G signal transmission state of a high-current high-frequency electrical connector plug applicable to network data transmission in a normal application state in the present disclosure;

FIG. 19 is a summary list of an Ethernet performance test project for a high-current high-frequency electrical connector plug applicable to network data transmission in the present disclosure;

FIG. 20 is a diagram illustrating a simulation state of Ethernet performance in Ansoft software for a high-current high-frequency electrical connector plug applicable to network data transmission in the present disclosure;

FIG. 21 is a field plot illustrating insertion loss in an Ethernet performance test for a high-current high-frequency electrical connector plug applicable to network data transmission in the present disclosure;

FIG. 22 is a field plot illustrating NEXT (Near end crosstalk) in an Ethernet performance test for a high-current high-frequency electrical connector plug applicable to network data transmission in the present disclosure;

FIG. 23 is a field plot illustrating FEXT (Far end crosstalk) in an Ethernet performance test for a high-current high-frequency electrical connector plug applicable to network data transmission in the present disclosure;

FIG. 24 is a field plot illustrating return loss in an Ethernet performance test for a high-current high-frequency electrical connector plug applicable to network data transmission in the present disclosure;

FIG. 25 is a summary list of an Ethernet performance test project for a high-current high-frequency electrical connector plug applicable to network data transmission in the present disclosure;

FIG. 26 is a diagram illustrating a simulation state of Ethernet performance in Ansoft software for a high-current high-frequency electrical connector plug applicable to network data transmission in the present disclosure;

FIG. 27 is a field plot illustrating insertion loss in an Ethernet performance test for a high-current high-frequency electrical connector plug applicable to network data transmission in the present disclosure;

FIG. 28 is a field plot illustrating VSWR (Voltage Standing Wave Ratio) in an Ethernet performance test for a high-current high-frequency electrical connector plug applicable to network data transmission in the present disclosure;

FIG. 29 is a field plot illustrating impedance in an Ethernet performance test for a high-current high-frequency electrical connector plug applicable to network data transmission in the present disclosure; and

FIG. 30 is a field plot illustrating return loss in an Ethernet performance test for a high-current high-frequency electrical connector plug applicable to network data transmission in the present disclosure.

1: plug housing; 11: left rounded part; 12: right rounded part; 13: left chamfered part; 14: right chamfered part; 15: upper limiting notch; 16: lower limiting notch; 2: bayonet socket; 21: upper terminal block; 22: lower terminal block; 23: insulating plastic body; 231: insertion cavity; 232: left fool-proofing inwardly-extending part; 233: right fool-proofing inwardly-extending part; 234: left avoidance notch; 235: right avoidance notch; 236: upper limiting protrusion; 237: lower limiting protrusion; 24: left hook member, 241: left hook; 25: right hook member; and 251: right hook.

### DETAILED DESCRIPTION

In the description of the present disclosure, it should be understood that the orientations or positional relationships indicated by the terms “front”, “rear”, “up”, “down”, “left”, “right”, etc. are based on the orientations or positional relationships shown in the accompanying drawings and are merely for ease in describing the present disclosure and simplifying this description, but not to indicate or imply that an indicated device or element must have a particular orientation and be constructed and operated in a particular orientation, and thus they should not be construed as limitations on the present disclosure.

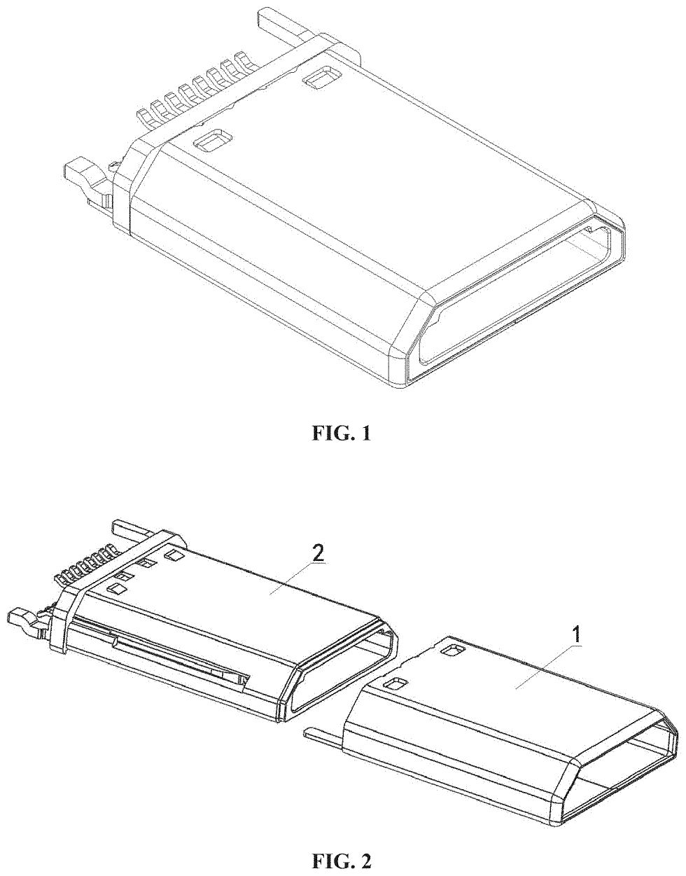

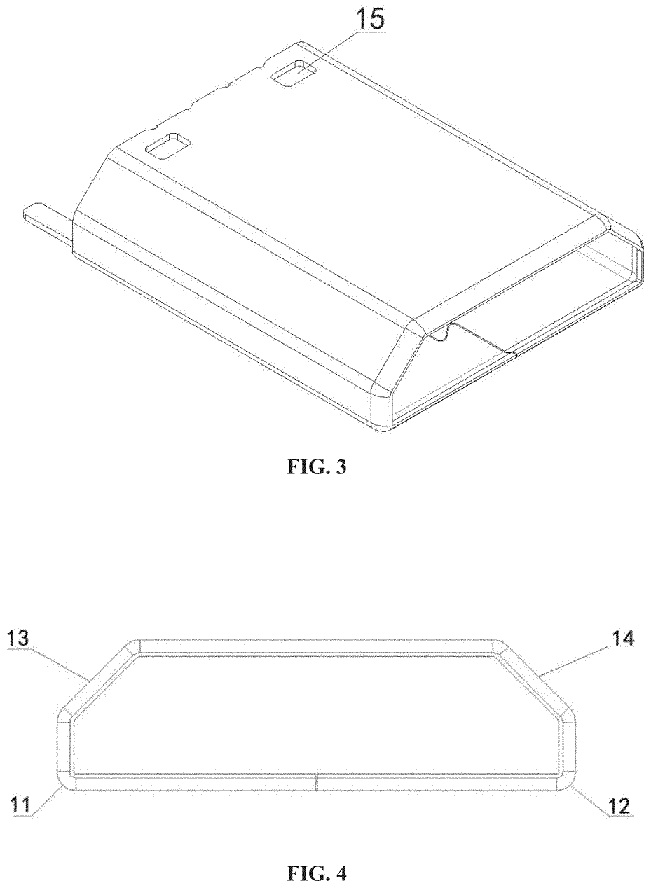

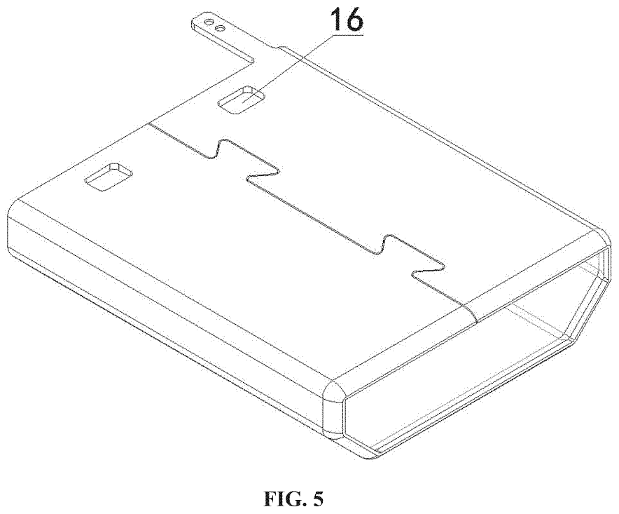

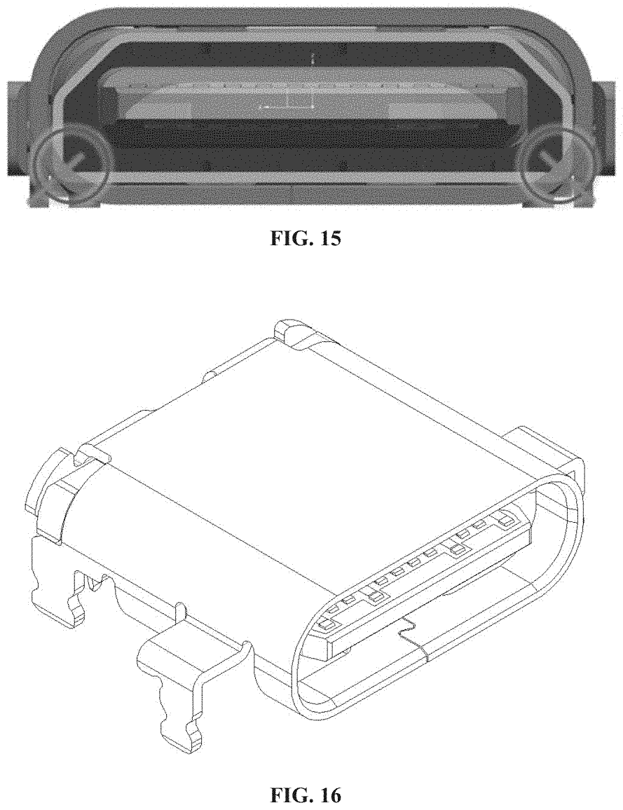

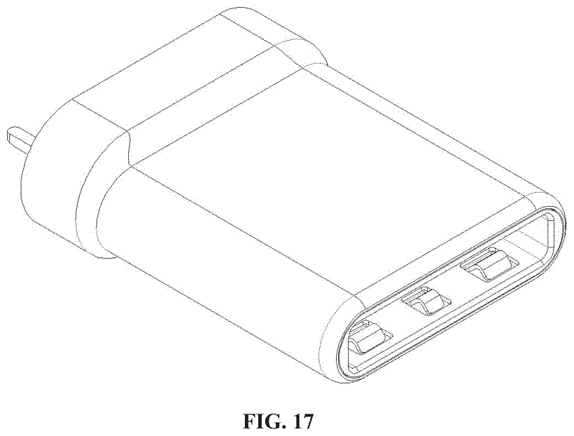

The following further describes the content of the present disclosure in detail in conjunction with the specific embodiments. FIG. 1 and FIG. 2 show a schematic 3D view and a schematic exploded view of a high-current high-frequency electrical connector plug applicable to network data transmission in the present disclosure respectively. It can be seen that the electrical connector plug mainly includes a plug housing 1, a bayonet socket 2, etc. The bayonet socket 2 is inserted into the plug housing 1 in a front-rear direction, and a relative position thereof is locked. The bayonet socket 2 includes an upper terminal block 21, a lower terminal block 22 and an insulating plastic body 23. An insertion cavity 231 for placing a socket tongue of an electrical connector receptacle is formed in the insulating plastic body 23. The upper terminal block 21 and the lower terminal block 22 are inserted and fixed into a top wall and a bottom wall of the insertion cavity 231 respectively and each have one section extending into the insertion cavity 231. The periphery of the plug housing 1 is sequentially provided with a left rounded part 11, a right rounded part 12, a left chamfered part 13 and a right chamfered part 14. The left rounded part 11 is formed by round corner transition of a bottom wall and a left side wall of the plug housing 1 and has a radius not greater than 0.25 mm. The right rounded part 12 is formed by round corner transition of a right side wall and a bottom wall of the plug housing 1 and has a radius not greater than 0.25 mm. During the manufacturing and forming process of an electrical connector, an electrical connector receptacle matched with the electrical connector plug further needs to adaptively be structurally changed (as shown in FIG. 3 to FIG. 10). Thus, an insertion part of the plug housing 1 adopts a special-shaped design (one part extends outwardly compared with a rounded part of a conventional housing) so as not to be matched with conventional receptacles. When multiple electrical connectors are arranged side by side, conventional electrical connector receptacles do not adopt an adaptive remodel design, and therefore workers certainly fail to insert the remodeled plug into conventional receptacles due to interference even if they perform misoperation (as shown in FIG. 15), mixed insertion and misinsertion of the connector plug into conventional receptacles are effectively prevented, and finally it is ensured that signals are correctly transmitted.

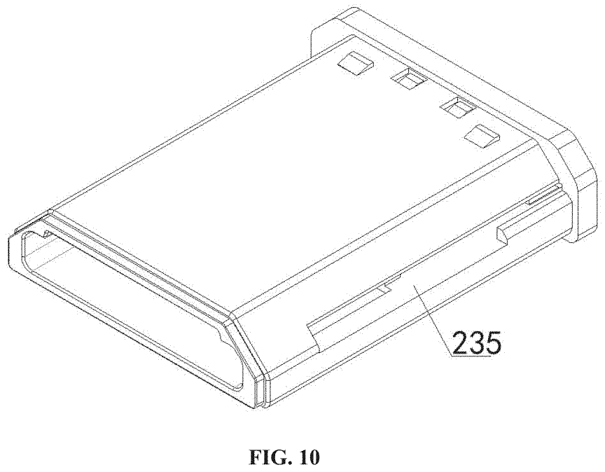

As a further optimization on the high-current high-frequency electrical connector plug applicable to network data transmission, the insulating plastic body 23 is further additionally provided with a left fool-proofing inwardly-extending part 232 and a right fool-proofing inwardly-extending part 233. The left fool-proofing inwardly-extending part 232 and the right fool-proofing inwardly-extending part 233 are both formed by extending downwardly from a top wall of the insertion cavity 231 and are opposite to each other (as shown in FIG. 9 and FIG. 10). Thus, an insulating plastic body of a conventional electrical connector receptacle is not provided with avoidance structures, and therefore insertion fails in case of misinsertion because the left fool-proofing inwardly-extending part 232 and the right fool-proofing inwardly-extending part 233 may be interfered with by the insulating plastic body of the conventional electrical connector receptacle.

It should be noted that an electrical connector receptacle needs to be adaptively structurally improved to be correctly inserted into the electrical connector plug in the present disclosure. Specifically, a rounding size of an electrical connector receptacle housing needs to be reduced to be matched with the left rounded part 11 and the right rounded part 12; and accordingly a fool-proofing protruding strip further needs to be disposed on a socket tongue of the electrical connector receptacle to be matched with the left fool-proofing inwardly-extending part 232 and the right fool-proofing inwardly-extending part 233 (as shown in FIG. 13 and FIG. 14).

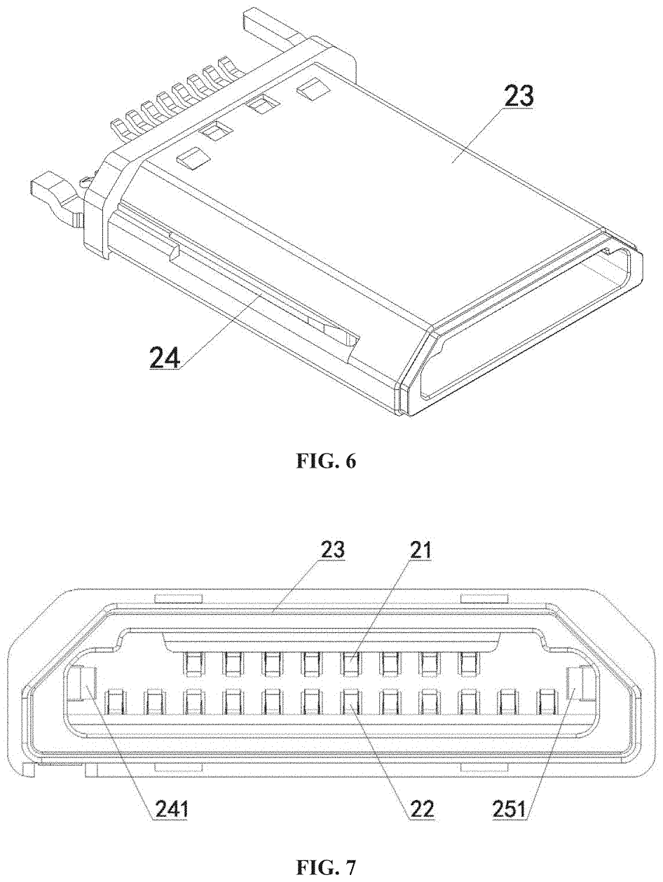

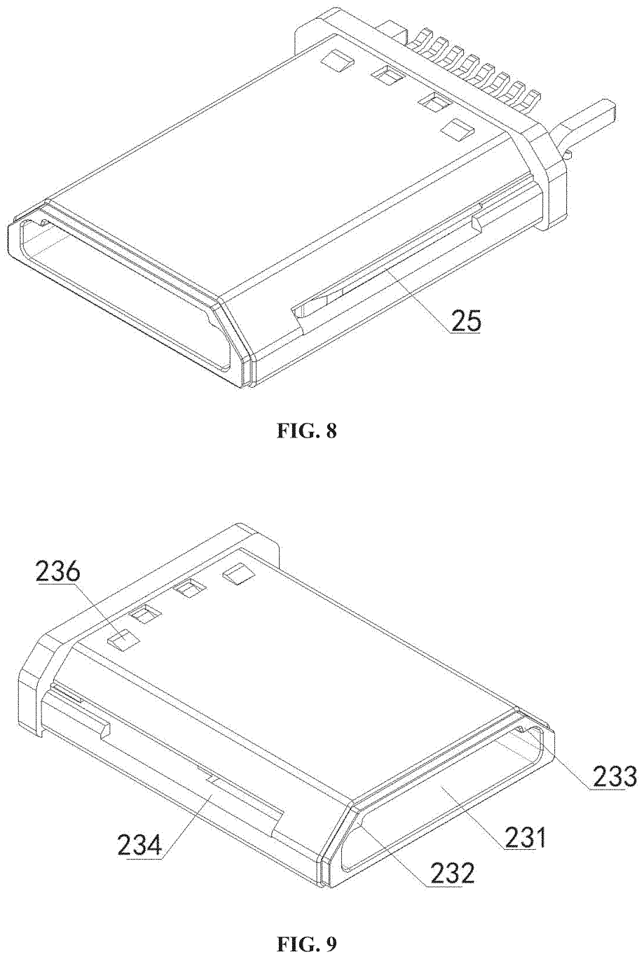

It is learned that insertion connection reliability of the electrical connector plug and the electrical connector receptacle has a significant impact on a signal transmission process. In view of this, accordingly the bayonet socket 2 of the electrical connector plug is further correspondingly additionally provided with a left hook member 24 and a right hook member 25. The left hook member 24 and the right hook member 25 are both inserted and fixed into the insulating plastic body 23 and are opposite to each other in a left-right direction. A left hook 241 extends rightwards from a right side wall of the left hook member 24. A right hook 251 extends leftwards from a left side wall of the right hook member 25 (as shown in FIG. 6, FIG. 7 and FIG. 8). Thus, when the electrical connector plug is inserted into the electrical connector receptacle, the left hook member 24 and the right hook member 25 disposed on two sides of the insulating plastic body 23 of the electrical connector plug slide along two side walls of the socket tongue of the electrical connector receptacle all the time until entering a left slot and a right slot matched with the left hook 241 and the right hook 251 in a one-to-one correspondence manner, and therefore reliable connection between the electrical connector plug and the electrical connector receptacle is implemented.

As a further optimization on the above technical solution, a left avoidance notch 234 may further be formed on a left side wall of the insulating plastic body 23 right corresponding to an insertion position of the left hook member 24. A right avoidance notch 235 may further be formed on a right side wall of the insulating plastic body 23 right corresponding to an insertion position of the right hook member 25 (as shown in FIG. 6, FIG. 8, FIG. 9 and FIG. 10). Thus, on the premise of ensuring fixation reliability of the left hook member 24, the right hook member 25 to the insulating plastic body 23, the left hook member 24 and the right hook member 25 are made to have certain free elastic activity, and therefore on the premise of ensuring connection reliability of the electrical connector plug and the electrical connector receptacle, it is ensured that insertion and separation of the plug and the receptacle are smoothly and rapidly implemented.

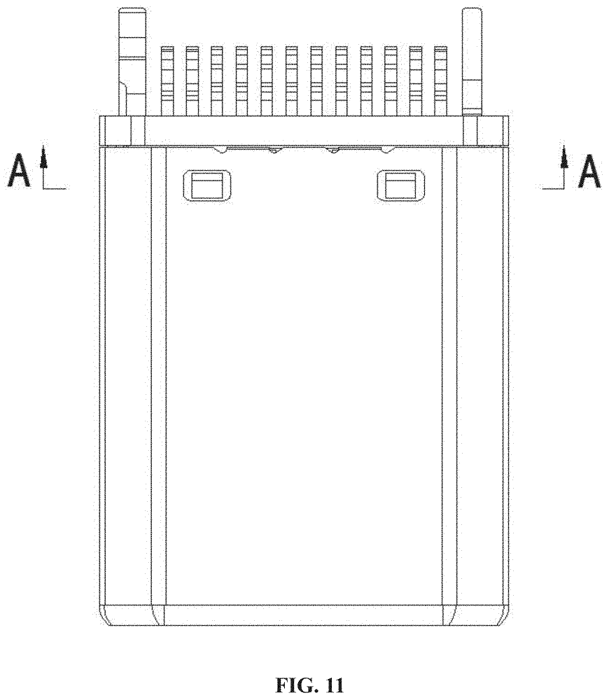

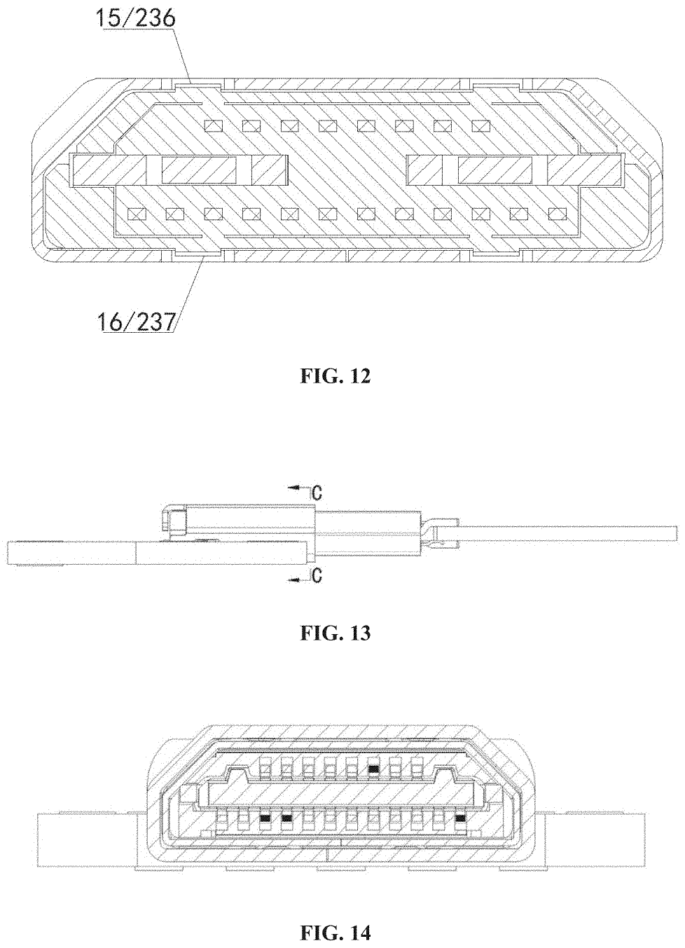

It is learned that fixation connection between the plug housing 1 and the insulating plastic body 23 may be implemented by various design forms. Furthermore, an implementation solution which is simple in structural design, high in connection reliability, easy to manufacture and implement, and rapid in assembly and disassembly is recommended herein. Specifically, as shown in FIG. 1, FIG. 2, FIG. 3, FIG. 5, FIG. 9, FIG. 10, FIG. 11 and FIG. 12, upper limiting notches 15 and lower limiting notches 16 are formed in a top wall and a bottom wall of the plug housing 1 respectively. Upper limiting protrusions 236 matched with the upper limiting notches 15 extend upwardly from a top wall of the insulating plastic body 23. Lower limiting protrusions 237 matched with the lower limiting notches 16 extend downwardly from a bottom wall of the insulating plastic body 23.

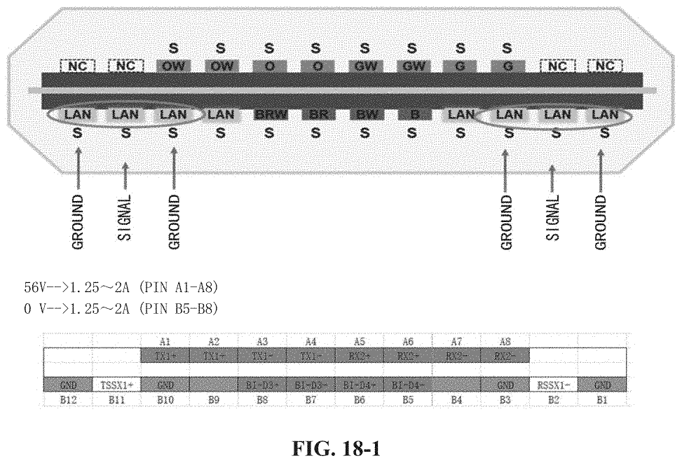

Finally, it should be further noted that, to make the high-current high-frequency electrical connector plug applicable to network data transmission have two different signal transmission modes, the number of contact terminals included in the upper terminal block 21 and the number of contact terminals included in the lower terminal block 22 are further different in accordance with the requirements of code for design of signal terminals. A high-current transmission function of the electrical connector plug may be realized while Ethernet communication is implemented by configuring a PIN through a PoE protocol, and meanwhile transmittable 15G (single-terminal)-20G (differential) high-frequency data signals are set up by configuring a single high-speed signal pair. FIG. 18-1 shows a Pin definition form in a long-distance 15G single-terminal signal transmission state for high-current high-frequency electrical connector plug applicable to network data transmission in a normal application state in the present disclosure. FIG. 18-2 shows a Pin definition form in a long-distance 20G differential signal transmission state for a high-current high-frequency electrical connector plug applicable to network data transmission in a normal application state in the present disclosure.

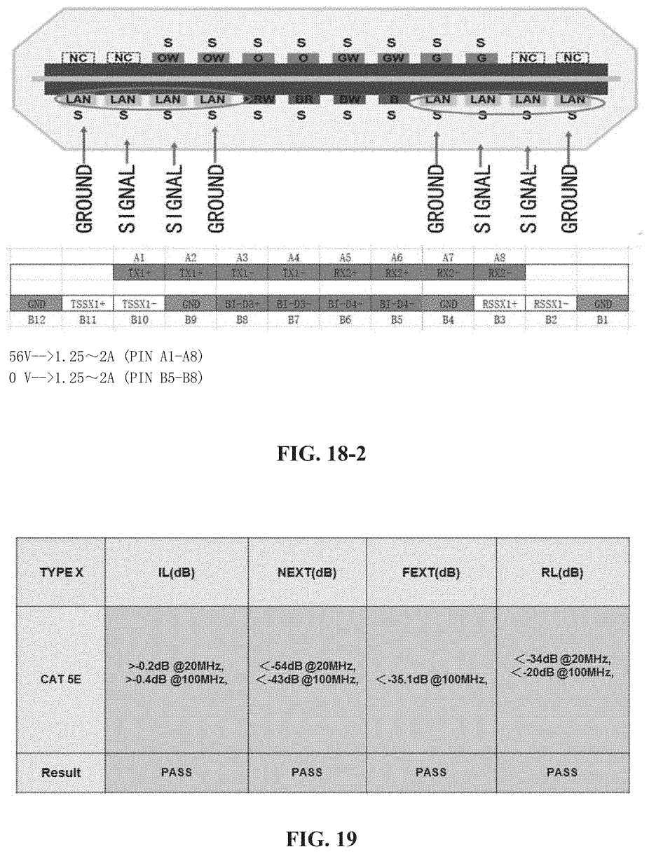

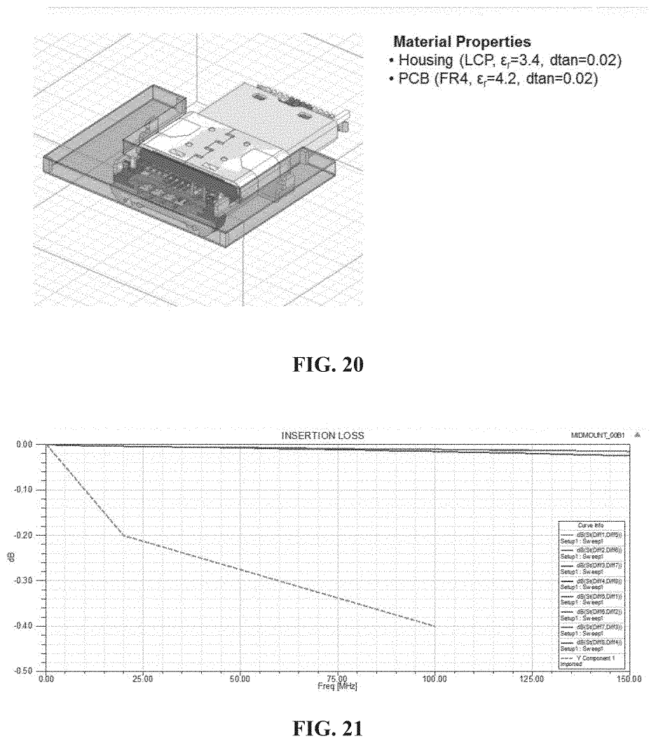

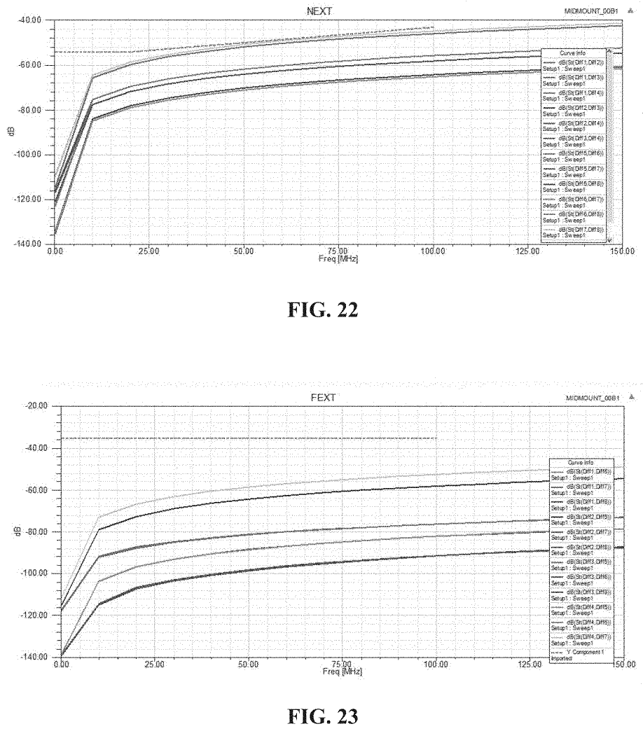

FIG. 19 to FIG. 24 are plots illustrating results of an Ethernet performance test for a high-current high-frequency electrical connector plug applicable to network data transmission in the present disclosure.

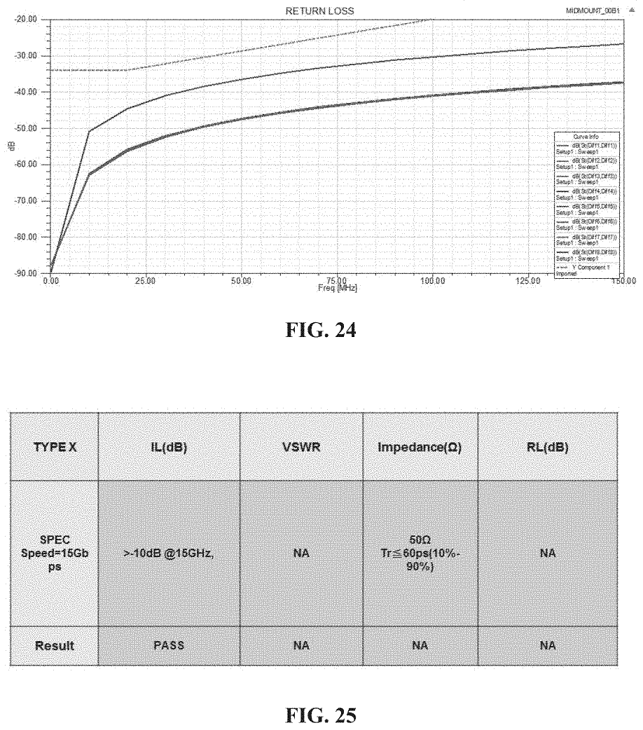

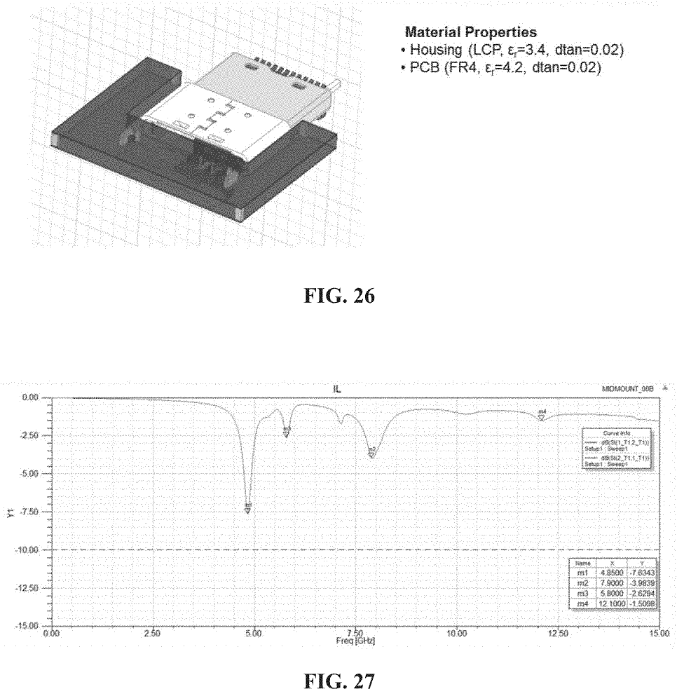

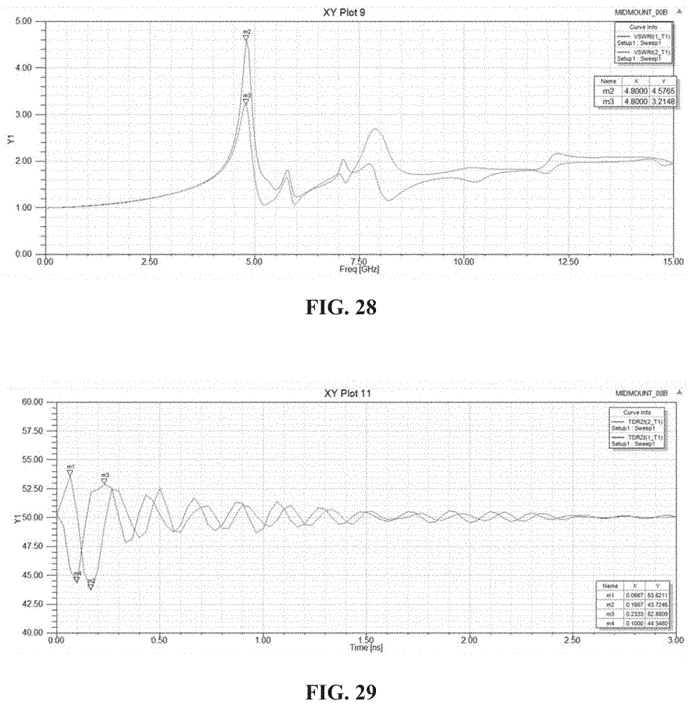

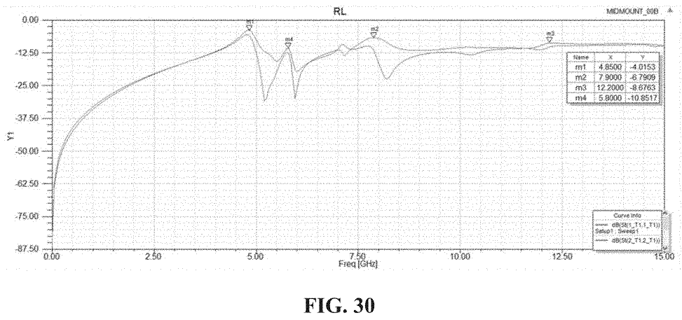

FIG. 25 to FIG. 30 are plots illustrating results of a high-speed transmission performance test for a high-current high-frequency electrical connector plug applicable to network data transmission in the present disclosure.

Due to the above description of the disclosed embodiments, those skilled in the art may implement or use the present disclosure. Various modifications to these embodiments are readily apparent to those skilled in the art, and the general principles defined herein may be implemented in other embodiments without departing from the gist or scope of the present disclosure. Therefore, the present disclosure is not limited to the embodiments shown herein but falls within the widest scope consistent with the principles and novel features disclosed herein.

What is claimed is:

1. A high-current high-frequency electrical connector plug applicable to network data transmission, comprising:
a plug housing having a periphery around which are provided with:
a left rounded part formed by round corner transition of a bottom wall and a left side wall of the plug housing and having a radius not greater than 0.25 mm;
a right rounded part formed by round corner transition of a right side wall and a bottom wall of the plug housing and having a radius not greater than 0.25 mm;
a left chamfered part formed by chamfering of a left side wall and a top wall of the plug housing; and
a right chamfered part formed by chamfering of a right side wall and a top wall of the plug housing; and
a bayonet socket, configured to be inserted and locked in the plug housing, and comprising:
an insulating plastic body provided with an insertion cavity;
an upper terminal block fixed to a top wall of the insertion cavity and extending out of the insertion cavity; and
a lower terminal block fixed to a bottom wall of the insertion cavity and extending out of the insertion cavity.

2. The electrical connector plug according to claim 1, wherein:
the insulating plastic body further comprises a left fool-proofing inwardly-extending part and a right fool-proofing inwardly-extending part; and
the left fool-proofing inwardly-extending part and the right fool-proofing inwardly-extending part are both formed by extending downwardly from the top wall of the insertion cavity.

3. The electrical connector plug according to claim 1, wherein the bayonet socket further comprises:
a left hook member, fixed into the insulating plastic body, and comprising a left hook formed by extending rightwards from a right side wall of the left hook member; and
a right hook member, fixed into the insulating plastic body, and comprising a right hook formed by extending leftwards from a left side wall of the right hook member.

4. The electrical connector plug according to claim 3, wherein the insulating plastic body further comprises:
a left avoidance notch, formed on a left side wall of the insulating plastic body and configured to insert the left hook member; and
a right avoidance notch, formed on a right side wall of the insulating plastic body and configured to insert the right hook member.

5. The electrical connector plug according to claim 1, wherein:
an upper limiting notch and a lower limiting notch are formed on the top wall and the bottom wall of the plug housing respectively; and
an upper limiting protrusion matched with the upper limiting notch is formed on a top wall of the insulating plastic body, the upper limiting protrusion is formed by extending upwardly from the top wall of the insulating plastic body, a lower limiting protrusion matched with the lower limiting notch is formed on a bottom wall of the insulating plastic body, and the lower limiting protrusion is formed by extending downwardly from the bottom wall of the insulating plastic body.
